(19) United States
(12) Patent Application Publication
(10) Pub. No.: US 2011/0053520 A1
(43) Pub. Date: Mar. 3, 2011

(54) COMMUNICATION SYSTEM

(75) Inventors: Hidenori Imagawa, Kawasaki (JP); Tsuguhisa Kuwada, Kawasaki (JP); Takasi Saitou, Kawasaki (JP)

(73) Assignee: FUJITSU LIMITED, Kawasaki-shi (JP)

(21) Appl. No.: 12/855,062

(22) Filed: Aug. 12, 2010

(30) Foreign Application Priority Data
Aug. 31, 2009 (JP) 2009-199396

(51) Int. Cl. H04B 7/00

(52) U.S. Cl. 455/69

(57) ABSTRACT

A communication system includes a transmitter and a receiver. The transmitter includes a data transmitting section configured to transmit data. The receiver includes a data receiving section, a memory, a memory managing section, and a control section. The data receiving section is configured to receive the data transmitted from the transmitter. The memory is configured to store the received data. The memory managing section is configured to manage a total number of free regions discretely allocated on the memory. The control section is configured to perform a control process in accordance with the total number of the free regions on the memory, the control process including at least one of request for starting flow control to the transmitter and reallocation of the data stored in the memory for reducing the total number of the free regions.

### CROSS-REFERENCE TO RELATED APPLICATION

This application is based upon and claims the benefit of priority of the prior Japanese Patent Application No. 2009-199396, filed on Aug. 31, 2009, the entire contents of which are incorporated herein by reference.

### FIELD

The embodiments discussed herein are related to a communication system. The communication system includes a system that performs radio data communication.

### BACKGROUND

In radio communication conforming to 3rd generation partnership project (3GPP) standards, data communication with a variable-sized packet format is performed using a data link protocol called radio link control (RLC) in a radio zone between a radio base station and a mobile station.

In an RLC layer, control of splitting data is performed on a transmitting side and control of merging the split data is performed on a receiving side. Memory control is also performed in association with the above-mentioned controls, such as obtaining a memory region to store data in the memory, and reading the stored data from the memory and then releasing the memory region.

In order to guarantee a transmission order of the split data to an upper layer in the case of a failure in transmitting/receiving data, control of retransmitting data is performed in the RLC layer. The control of retransmitting data includes a transmittal confirmation and a retransmission request. Control data, i.e., an RLC control protocol data unit (PDU), generated in the RLC layer may be used for the transmittal confirmation.

As a related art associated with memory control, a technology has been proposed, in which a usage rate of the memory of each switching apparatus is detected on a regular basis. Japanese Laid-open Patent Publication No. 2003-309645 discloses a related technique. Furthermore, a technology has been proposed, in which a base station stores data directed toward a mobile station in a buffer and performs flow control when buffer occupancy of the stored data has exceeded a threshold. PCT International Application Publication No. WO 2004-089027 discloses a related technique.

### SUMMARY

According to an aspect of the present invention, provided is a communication system including a transmitter and a receiver. The transmitter includes a data transmitting section configured to transmit data. The receiver includes a data receiving section, a memory, a memory managing section, and a control section. The data receiving section is configured to receive the data transmitted from the transmitter. The memory is configured to store the received data. The memory managing section is configured to manage a total number of free regions discretely allocated on the memory. The control section is configured to perform a control process in accordance with the total number of the free regions on the memory, the control process including at least one of request for starting flow control to the transmitter and reallocation of the data stored in the memory for reducing the total number of the free regions.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a communication system according to an embodiment of the present invention;

FIG. 2 is a diagram illustrating an example of a configuration of a radio communication system according to an embodiment of the present invention;

FIG. 3 is a diagram illustrating an example of a defragmentation process on a memory according to an embodiment of the present invention;

FIG. 4 is a diagram illustrating examples of information that serves as a criterion for determination according to an embodiment of the present invention;

FIG. 5 is a diagram illustrating an example of an operation flow of a determination process performed by a mobile station according to an embodiment of the present invention;

FIG. 6 is a diagram illustrating an example of a communication sequence between a radio base station and a mobile station according to an embodiment of the present invention;

FIG. 7 is a diagram illustrating divided areas of a memory according to an embodiment of the present invention;

FIG. 8 is a diagram illustrating an example of conventional memory control; and

FIG. 9 is a diagram illustrating an example of conventional memory control.

### DESCRIPTION OF EMBODIMENTS

In mobile communication systems developed in recent years, downsizing of cellular phones (mobile stations) is required, and the size of memories mounted in the cellular phones is limited. Under such circumstances, effective usage of limited memory regions is required so that an insufficient memory capacity may not become a bottleneck in communication. However, in conventional memory controls, memories have not been effectively used, and this leads to reduction in the efficiency of memory use.

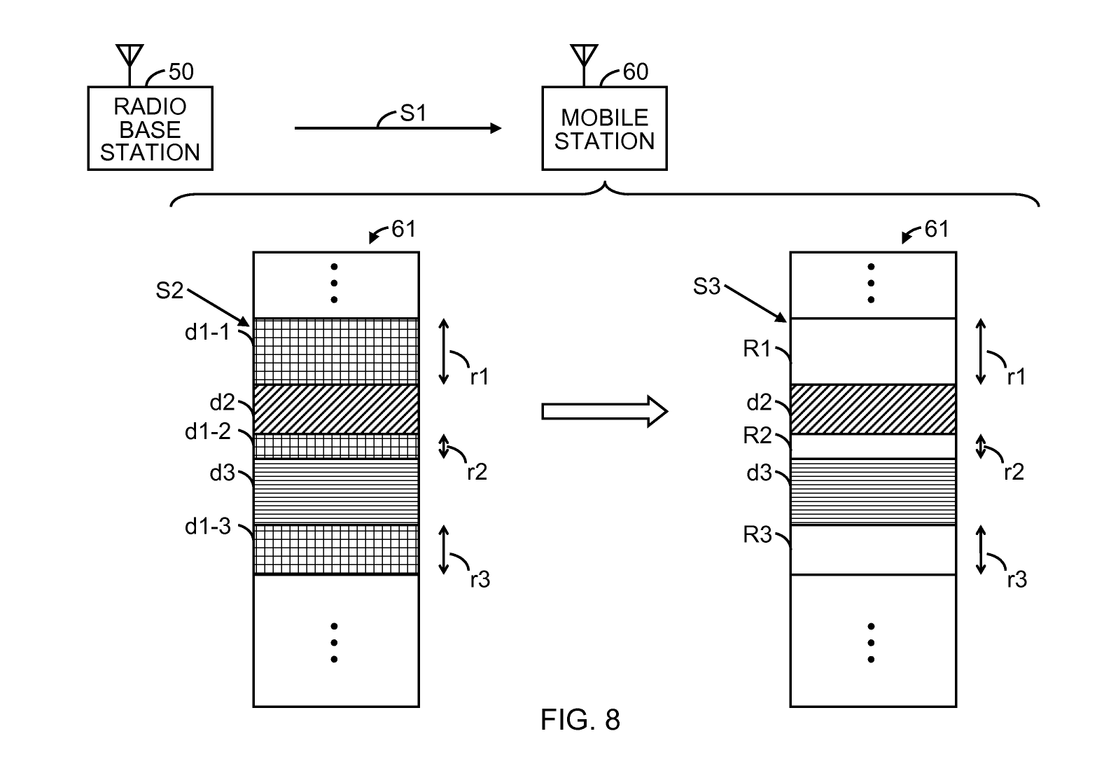

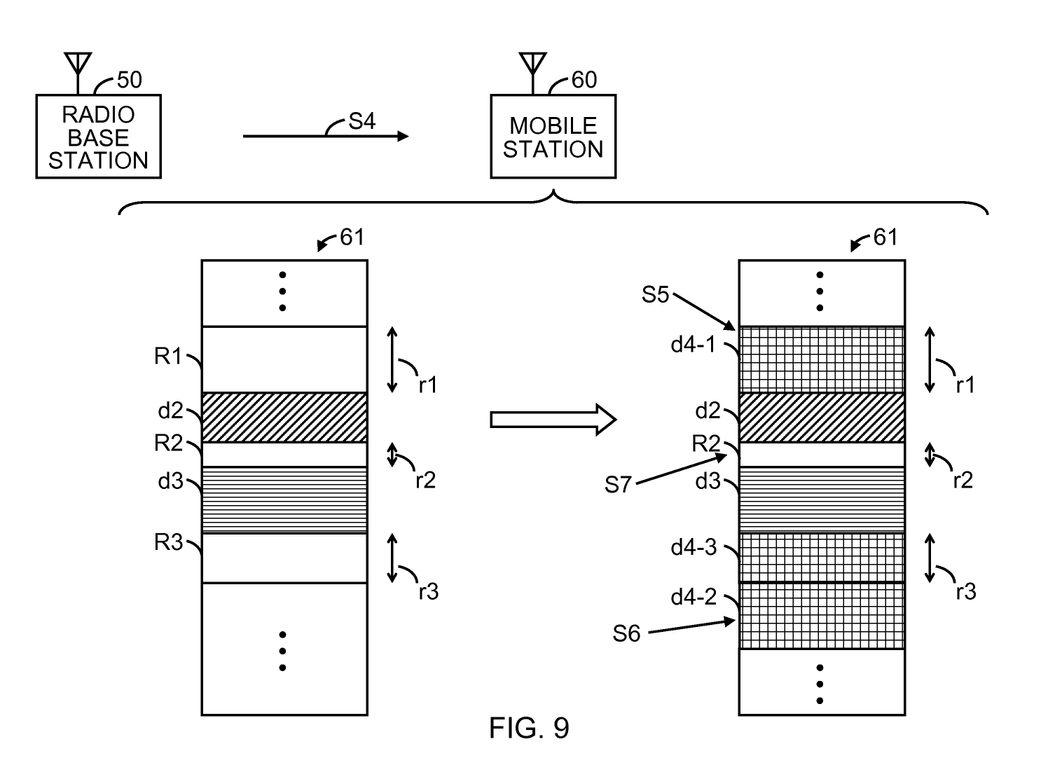

FIGS. 8 and 9 are diagrams for explaining problems of conventional memory control. A mobile station 60 has a memory 61, and stores, in the memory 61, downlink data that has been transmitted from a radio base station 50. The mobile station 60 stores the downlink data in the memory 61 basically in an order in which the mobile station 60 has received the downlink data. FIG. 8 illustrates operations S1 to S3, and FIG. 9 illustrates operations S5 to S7.

In operation S1, data d1-1 to d1-3 and data d2 and d3 are transmitted from the radio base station 50 to the mobile station 60. The data d1-1 to d1-3 have been obtained by splitting one stream of data into three.

In operation S2, assume that these data have reached the mobile station 60 in the order of data d1-1, d2, d1-2, d3, and d1-3. The mobile station 60 stores these data in the memory 61 in this order.

In operation S3, the mobile station 60 reads the data d1-1 to d1-3 from the memory 61 and merges them to perform a predetermined process for received data. As a result, free regions R1 to R3 have been generated as released regions on the memory 61.

In operation S4, data d4-1 to d4-3 are transmitted from the radio base station 50 to the mobile station 60. The data d4-1 to d4-3 have been obtained by splitting one stream of data into three.

In operation S5, assume that these data have reached the mobile station 60, in the order of data d4-1, d4-2, and d4-3. Assume further that the region size r1 of the free region R1 and the region size r3 of the free region R3 are the same as the data size of the data d4-1 and the data size of the data d4-3, respectively, and that the region size r2 of the free region R2 is smaller than the data size of the data d4-2. The data d4-1 may be stored in the free region R1, and the data d4-3 may be stored in the free region R3.

In operation S6, because the free region R2 is a storage region whose size is smaller than the data size of the data d4-2, it is impossible to store the data d4-2 in the free region R2. For this reason, the data d4-2 is stored in an unused region of the memory 61.

In operation S7, the free region R2 remains on the memory 61, as a region (a blank) unable to store data.

As discussed above, the radio base station 50 transmits not fixed-sized data but variable-sized data. Accordingly, when the above-discussed memory control is performed on such data, free regions are discretely generated on the memory 61. Because of generation of the free regions, the total capacity of available regions on the memory 61 is reduced. Thus, there is a problem that the efficiency of memory use is reduced.

When a failure has occurred in transmitting/receiving data between the radio base station 50 and the mobile station 60, control of retransmitting data is performed. Also in this case, the radio base station 50 splits and retransmits the data. When failures in transmitting/receiving data occur frequently, the number of retransmissions increases. Accordingly, a probability of generating a large number of discrete free regions on the memory 61 increases.

It is preferable to provide a communication system that achieves an improvement in the efficiency of memory use.

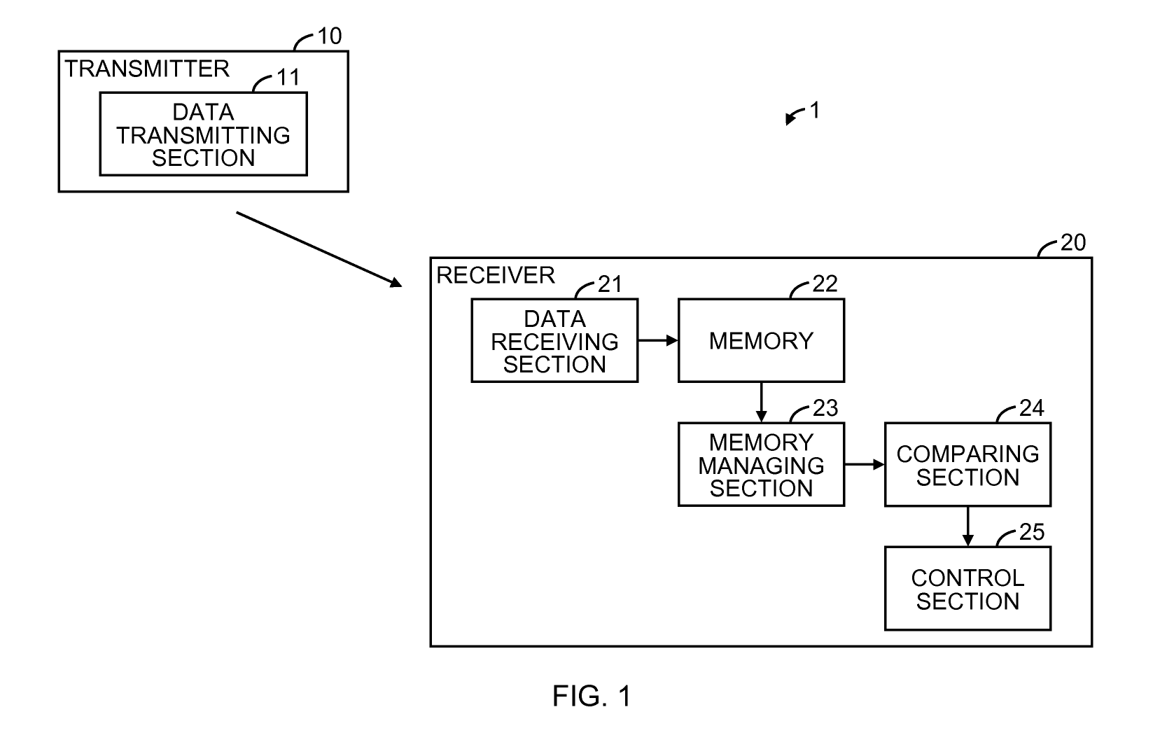

Hereinafter, embodiments of the present invention will be discussed with reference to the accompanying drawings. FIG. 1 illustrates an example of a configuration of a communication system 1 according to the present embodiment. The communication system 1 includes a transmitter 10 and a receiver 20. The transmitter 10 includes a data transmitting section 11. The receiver 20 includes a data receiving section 21, a memory 22, a memory managing section 23, a comparing section 24, and a control section 25. The communication system 1 is a system that performs radio communication between the transmitter 10 and the receiver 20.

Note that, in FIG. 1, the transmitter 10 and the receiver 20 are illustrated separately from each other for simplicity of description. In reality, a single communication apparatus may have both functions of the transmitter 10 for transmitting data to the receiver 20 of another communication apparatus and functions of the receiver 20 for receiving data transmitted by the transmitter 10 of another communication apparatus.

The data transmitting section 11 performs a process of transmitting data to the receiver 20. The process of transmitting data includes starting flow control in response to a request for starting flow control. The data receiving section 21 performs a process of receiving data transmitted from the transmitter 10. The memory 22 stores the received data. The memory managing section 23 manages a usage rate of the memory 22 and a total number of free regions discretely generated on the memory 22.

The comparing section 24 has a first threshold for the usage rate of the memory, and performs a comparing process of comparing the usage rate of the memory with the first threshold. The comparing section 24 has a second threshold for the total number of free regions, and performs a comparing process of comparing the total number of free regions with the second threshold.

The control section 25 performs, in accordance with results of the comparing process performed by the comparing section 24, a control process including at least one of request for starting flow control to the transmitter 10 and data reallocation on the memory 22.

Note that the term “flow control” generally refers to control of transmitting information data in accordance with the reception capability of a communication partner or a traffic status of a network. For example, when a transfer speed on a transmitting side is higher than a reception speed on a receiving side, both the transmitting side and the receiving side check a status of data transfer to prevent data loss due to data overflow of a buffer on the receiving side, thereby performing secure data transfer.

Examples of flow control performed on the transmitting side include, stopping data transmission upon receiving a request for starting flow control from the receiving side or reduction in a speed of data transmission even when not stopping data transmission, and transmitting retransmission data.

The term “data reallocation” refers to a process of reallocating data stored in the memory 22 in order to reduce fragmentation of free regions generated on the memory 22. Hereinafter, data reallocation is referred to as a “defragmentation” process.

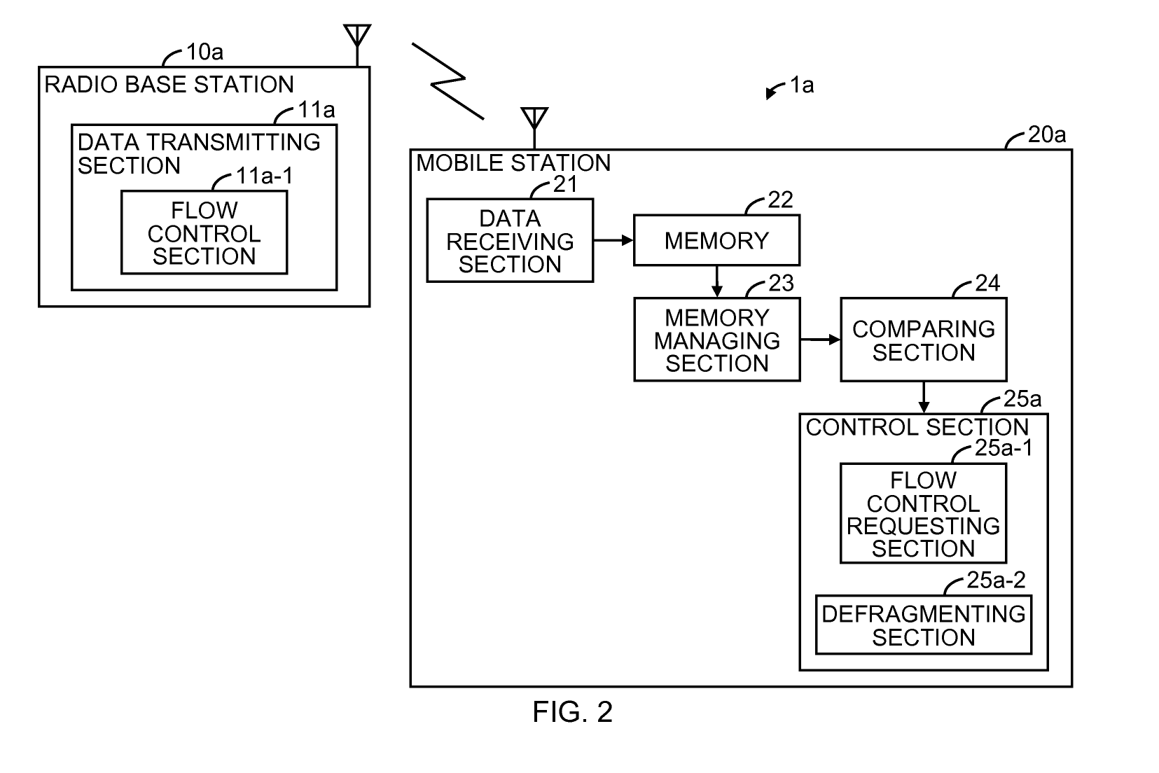

Hereinafter, a case in which the communication system 1 is a radio communication system will be discussed in detail by way of example. FIG. 2 illustrates an example of a configuration of a radio communication system 1a according to the present embodiment. The basic configuration of a radio communication system 1a is similar to the configuration of the communication system 1 illustrated in FIG. 1.

The radio communication system 1a includes a radio base station 10a and a mobile station 20a. The radio base station 10a includes a data transmitting section 11a, and the data transmitting section 11a includes a flow control section 11a-1. The flow control section 11a-1 starts or stops flow control of data transmission in accordance with a request for starting or stopping flow control that has been provided from the mobile station 20a.

The mobile station 20a includes the data receiving section 21, the memory 22, the memory managing section 23, the comparing section 24, and a control section 25a. The control section 25a includes a flow control requesting section 25a-1 and a defragmenting section 25a-2.

The flow control requesting section 25a-1 requests, in accordance with results of the comparing process performed by the comparing section 24, the radio base station 10a to start flow control or to stop flow control. The defragmenting section 25a-2 performs the defragmentation process on the memory 22 in accordance with results of the comparing process performed by the comparing section 24. The other component blocks are similar to those illustrated in FIG. 1.

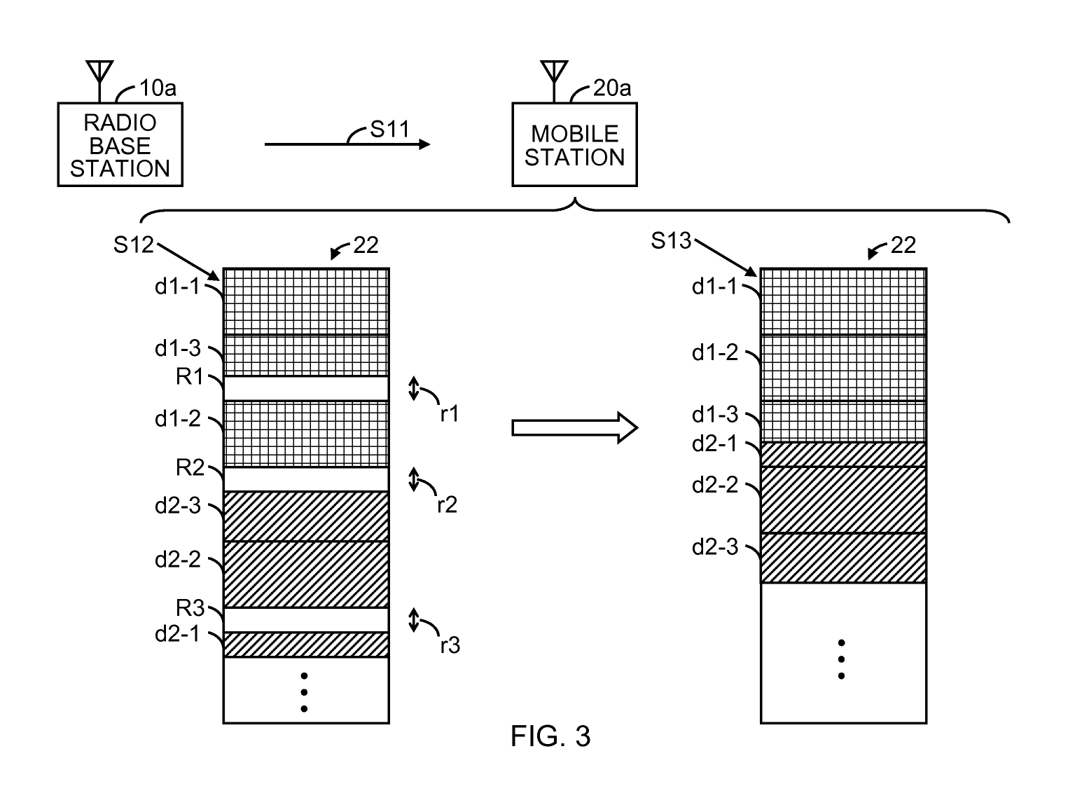

FIG. 3 illustrates an example of the defragmentation process on the memory 22 according to the present embodiment.

In operation S11, data d1-1 to d1-3 and data d2-1 to d2-3 are transmitted from the radio base station 10a to the mobile station 20a. The data d1-1 to d1-3 have been obtained by splitting one stream of data into three. Assume that the data d1-1 is start data, the data d1-2 is intermediate data, and the data d1-3 is end data.

The data d2-1 to d2-3 have been obtained by splitting one stream of data into three. Assume that the data d2-1 is start data, the data d2-2 is intermediate data, and the data d2-3 is end data.

In operation S12, assume that these data have reached the mobile station 20a in the order of data d1-1, d1-3, d1-2, d2-3, d2-2, and d2-1. The mobile station 20a stores these data in the memory 22 in this order. Assume that free regions (blanks) R1 to R3 have been generated on the memory 22 when these data were stored.

In operation S13, the defragmenting section 25a-2 reallocates the data stored in the memory 22 such that the fragments of data are stored from the top of the storage region in ascending order of memory addresses, thereby reducing fragmentation of free regions. Reduction in the total number of free regions is not performed simply by storing the fragments of data from the top of the storage region. The data are reallocated so that the fragments of data which may be merged into one stream of data may are stored in contiguous regions of the memory 22.

For example, if the data d1-1 to d1-3 are reallocated in the storage region in the same order as that before the reallocation, these data may be stored in the order of data d1-1, d1-3, and d1-2. In the present embodiment, however, these data are reallocated to be stored in the order of the data d1-1, d1-2, and d1-3.

Furthermore, if the data d2-1 to d2-3 are reallocated in the storage region in the same order as that before the reallocation, these data may be stored in the order of the data d2-3, d2-2, and d2-1. In the present embodiment, however, these data are reallocated to be stored in the order of data d2-1, d2-2, and d2-3.

In this manner, the defragmentation process is performed such that some fragments of one string of data, which have been stored discretely in the memory 22 and easy to be merged each other, are merged into a part of the original one string of data and reallocated in contiguous regions of the memory 22, whereby the total number of fragmented free regions may be reduced. Accordingly, not only an improvement in the efficiency of using the memory 22 may be achieved, but also an improvement in the operation efficiency may be achieved by facilitating merger of the data into the original one string of data when the data are read.

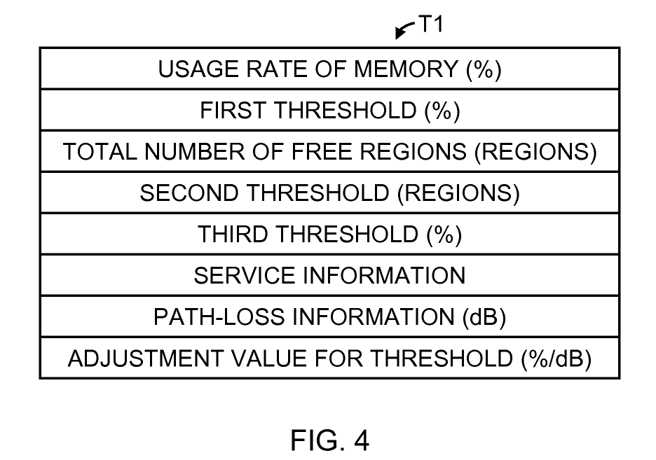

Next, information (the thresholds and so forth) that serves as a criterion for determination when the mobile station 20a requests to start or stop flow control and performs the defragmentation process will be discussed. FIG. 4 illustrates examples of information that serves as a criterion for determination according to the present embodiment. FIG. 4 illustrates a table T1 that is a list of information serving as a criterion for determination. The value of each of the various information listed in the table T1 is stored in a nonvolatile memory, for example, and used in the case when corresponding control is performed. As illustrated in FIG. 4, the table T1 includes a usage rate of the memory, a first threshold, a total number of free regions, a second threshold, a third threshold, service information, path-loss information, and an adjustment value for threshold.

The usage rate of the memory indicates a proportion (%) of the storage regions used to store received data to the entire storage region of the memory 22. The first threshold is a threshold for requesting to start flow control. The unit of the first threshold is % that is the same as the unit of the usage rate of the memory. Supposing that the default value of the first threshold is, for example, about 95%, in this case, when the usage rate of the memory has exceeded 95%, a request for starting flow control may be made.

The total number of free regions is the total number of free regions (the total number of blanks) on the memory 22 that is managed by the memory managing section 23. The second threshold is a threshold for starting the defragmentation process. Supposing that the default value of the second threshold is, for example, ten, in this case, when the total number of free regions has exceeded ten, the defragmentation process may be performed.

The third threshold is a threshold for requesting to stop flow control. The unit of the third threshold is % that is the same as the unit of the usage rate of the memory. Supposing that the default value of the third threshold is, for example, about 80%, in this case, when the usage rate of the memory has not exceeded 80% any longer, a request for stopping flow control may be made.

The service information indicates the received data is which one of a control signal, sound data, and service data other than the control signal and the sound data. Control signals and sound data may be preferable to be processed in real time. Therefore, the flow control may not be performed when the received data is a control signal or sound data.

The path-loss information indicates transmission path loss of the received data. The unit of the path-loss information is dB. The data receiving section 21 calculates the path-loss information from the intensity of the received data. It is supposed that the transmission path loss of the received data is, for example, in the range from 0 dB to −150 dB.

The adjustment value for threshold is a coefficient for adjusting the first threshold and the third threshold in accordance with the path-loss information. The unit of the threshold adjustment value is %/dB. It is supposed that the default value of the threshold adjustment value is, for example, 0.1%/dB.

Here, the comparing section 24 adaptively adjusts the first threshold or the third threshold in accordance with a status of the transmission path loss of the received data. Equations for calculating the adjusted first threshold and the adjusted third threshold will be illustrated as Equations (1) and (2).

(adjusted first threshold)=(default value of first threshold)+(threshold adjustment value)×(path-loss information) (1)

(adjusted third threshold)=(default value of third threshold)+(threshold adjustment value)×(path-loss information) (2)

Note that the adjusted first threshold is approximately in the range from 80% to 95%, and the adjusted third threshold is approximately in the range from 65% to 80%. Whether the request for starting or stopping flow control is to be made is determined using the thresholds based on a measured value of transmission path loss between the radio base station 10a and the mobile station 20a, whereby a highly accurate determination may be realized in accordance with a real environment of the transmission path.

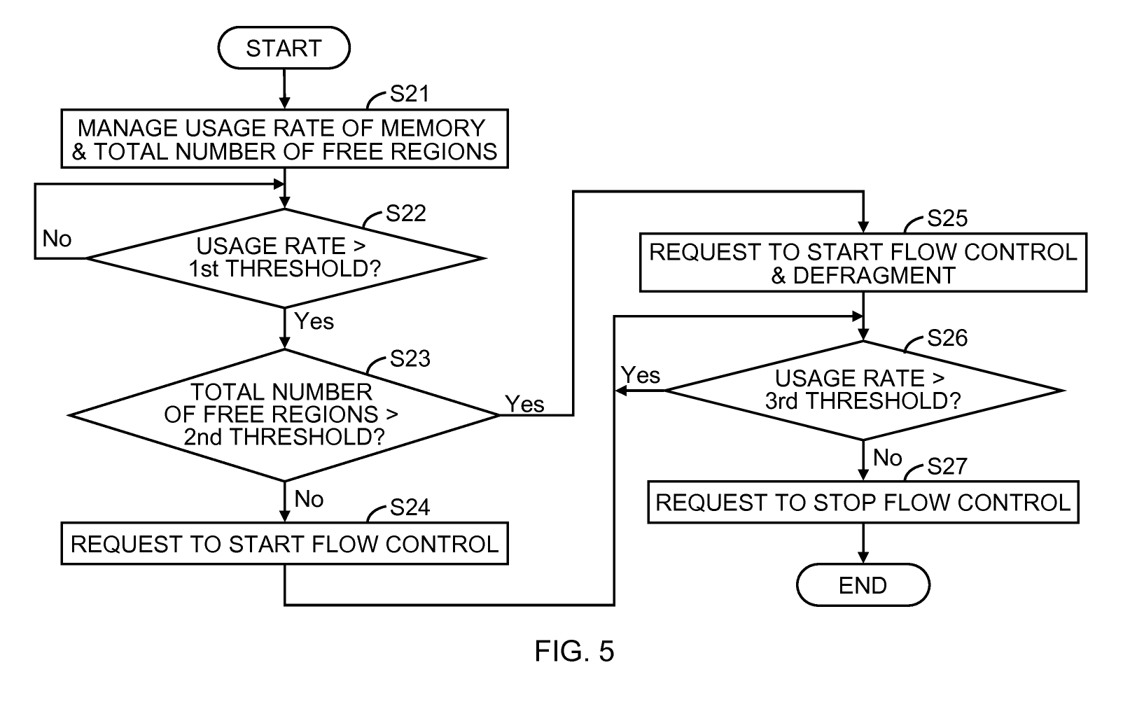

Next, the determination process and the control process based on the determination result performed in the mobile station 20a will be discussed. FIG. 5 illustrates an example of an operation flow of the determination process performed by the mobile station 20a according to the present embodiment.

In operation S21, the memory managing section 23 manages the usage rate of the memory of the memory 22 and the total number of free regions that are discretely generated on the memory 22.

In operation S22, the comparing section 24 compares the usage rate of the memory, which is managed by the memory managing section 23, with the first threshold. When the current usage rate of the memory has exceeded the first threshold (“Yes” in operation S22), the mobile station 20a advances the process to operation S23. When the current usage rate of the memory has not exceeded the first threshold (“No” in operation S22), the comparing section 24 continues performing the same determination process.

In operation S23, the comparing section 24 compares the total number of free regions generated on the memory 22, which is managed by the memory managing section 23, with the second threshold. When the current total number of free regions has not exceeded the second threshold, the mobile station 20a advances the process to operation S24. When the current total number of free regions has exceeded the second threshold, the mobile station 20a advances the process to operation S25.

In operation S24, the flow control requesting section 25a-1 requests the radio base station 10a to start flow control.

In operation S25, the flow control requesting section 25a-1 requests the radio base station 10a to start flow control. Further, the defragmenting section 25a-2 performs the defragmentation process discussed with reference to FIG. 3 on the memory 22.

In operation S26, the comparing section 24 compares the usage rate of the memory, which is managed by the memory managing section 23, with the third threshold. When the current usage rate of the memory has not exceeded the third threshold (“No” in operation S26), the mobile station 20a advances the process to operation S27. When the current usage rate of the memory has exceeded the third threshold (“Yes” in operation S26), the comparing section 24 continues performing the same determination process.

In operation S27, the flow control requesting section 25a-1 requests the radio base station 10a to stop flow control.

As discussed above, in the mobile station 20a, when the usage rate of the memory has exceeded the first threshold, the request for starting flow control is made. The defragmentation process is performed when the usage rate of the memory has exceeded the first threshold and the total number of free regions has exceeded the second threshold.

The reason for this is that, in a case in which the total number of free regions is small, an improvement in the usage rate of the memory may not be expected even when the defragmentation process is performed. Thus, only the flow control is employed in a case where the total number of free regions is small and the usage rate of the memory has increased. An improvement in the usage rate of the memory may be achieved with the above-discussed control.

In the above discussion, the first threshold is used as a threshold for requesting to start flow control, and the third threshold, which is different from the first threshold, is used as a threshold for requesting to stop flow control.

The two different thresholds are used to prevent requests for starting and stopping flow control from being continuously made. A margin for switching between the request for starting flow control and the request for stopping flow control is provided to reduce deterioration of the efficiency of transmission, occurrence of a malfunction, and so forth.

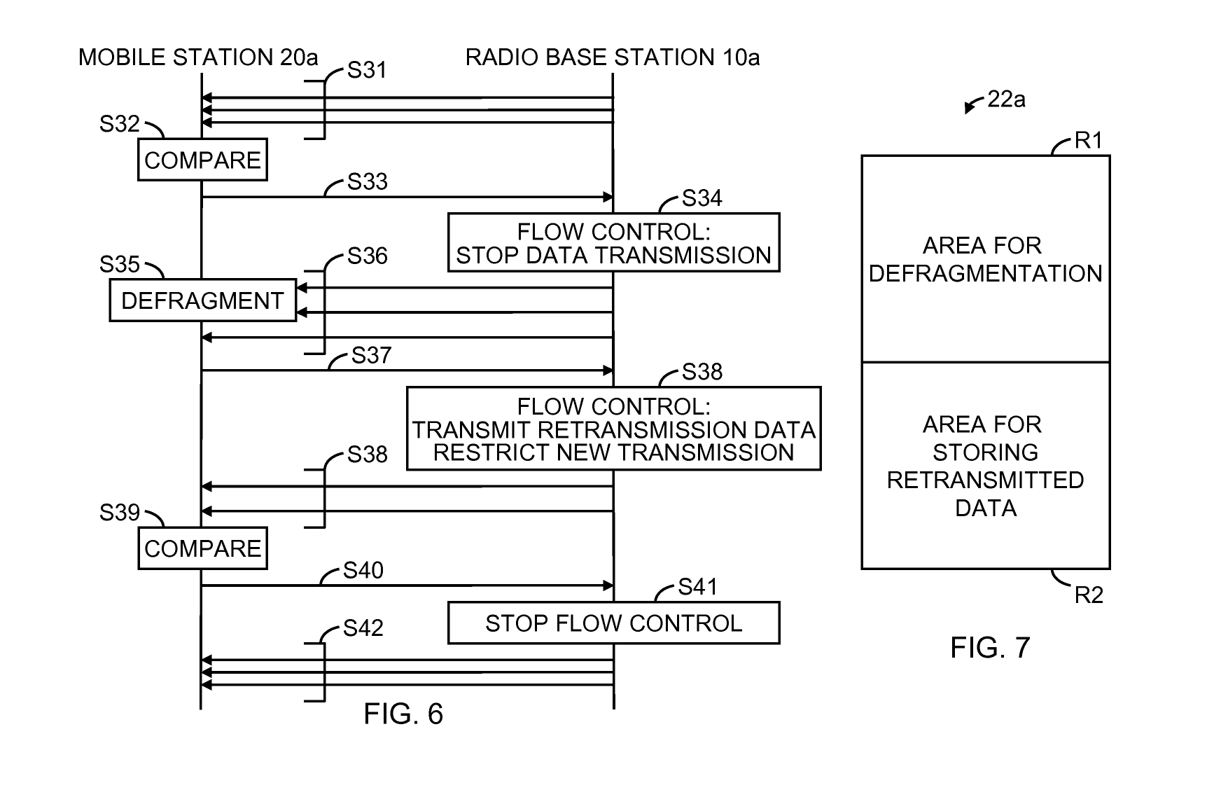

Next, communication performed between the radio base station 10a and the mobile station 20a will be discussed. FIG. 6 illustrates an example of a communication sequence between the radio base station 10a and the mobile station 20a according to the present embodiment.

In operation S31, the radio base station 10a transmits new data to the mobile station 20a.

In operation S32, the mobile station 20a stores the received data in the memory 22, and compares the usage rate of the memory with the first threshold and the total number of free regions with the second threshold. Herein, it is supposed that the mobile station 20a has determined that the usage rate of the memory has exceeded the first threshold and the total number of free regions has exceeded the second threshold.

In operation S33, the mobile station 20a transmits a request message for starting flow control to the radio base station 10a.

In operation S34, the radio base station 10a stops, as flow control, data transmission.

In operation S35, the mobile station 20a performs the defragmentation process on the memory 22.

In operation S36, the radio base station 10a periodically transmits, to the mobile station 20a, a request message for restarting data transmission.

In operation S37, when the defragmentation process has finished, the mobile station 20a transmits, to the radio base station 10a, a response message for restarting data transmission.

In operation S38, upon receiving the response message for restarting data transmission, the radio base station 10a starts data transmission. However, data transmission is performed within the scope of the flow control, that is, retransmission data may be preferentially transmitted, and new data may be restricted in transmission.

The retransmission data is some fragments of split data, which have not yet been transmitted to the mobile station 20a because data transmission has temporarily been stopped due to flow control. By transmitting the retransmission data preferentially to the mobile station 20a, the mobile station 20a may merge some fragments of split data that have already been received with the retransmission data, and may promptly perform a predetermined process for received data.

As discussed above, the radio base station 10a preferentially transmits retransmission data so that the mobile station 20a may remove data which have been accumulated in the memory 22. Accordingly, the transmitted data may be prevented from being discarded. Further, the radio base station 10a may prevent downlink data from being unnecessarily transmitted. Thus, downlink resources may be effectively utilized.

In operation S39, the mobile station 20a compares the usage rate of the memory with the third threshold. Here, it is supposed that the mobile station 20a has determined that the usage rate of the memory has not exceeded the third threshold.

In operation S40, the mobile station 20a requests the radio base station 10a to stop the flow control.

In operation S41, the radio base station 10a stops the flow control.

In operation S42, the radio base station 10a transmits new data.

Next, a case of dividing the storage region will be discussed. The storage region of the memory 22 is divided into a plurality of areas, and each of the divided areas is used in a different manner from each other. FIG. 7 illustrates divided areas of a memory 22a according to the present embodiment. The storage region of a memory 22a is divided into an area R1 (a first area) and an area R2 (a second area).

In a usual case of storing received data, the area R1 of the memory 22a is used to store the received data. In defragmentation, the defragmenting section 25a-2 performs the defragmentation process on the area R1. The retransmission data received from the radio base station 10a is stored in the area R2 during defragmentation.

As discussed above, the storage region of the memory is divided into a plurality of areas, and, when the defragmentation process is performed on one of the plurality of areas, retransmission data is stored in another one of the areas. Accordingly, in the radio base station 10a, retransmission data may be received during defragmentation without stopping data transmission.

As discussed above, the communication system 1 may improve the usage rate of the memory, whereby preventing discard of transferred data due to a memory shortage and a reduction in throughput. The size of a memory mounted on the mobile station 20a may be reduced, and downsizing of the mobile station 20a and reduction in the weight of the mobile station 20a may also be expected. From the viewpoint of the entire system, downlink data may be prevented from being unnecessarily transmitted. Thus, the efficiency of using downlink resources may be improved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system, comprising:
a transmitter including a data transmitting section configured to transmit data; and
a receiver including:
a data receiving section configured to receive the data transmitted from the transmitter,
a memory configured to store the received data,
a memory managing section configured to manage a total number of free regions discretely allocated on the memory, and
a control section configured to perform a control process in accordance with the total number of the free regions on the memory, the control process including at least one of request for starting flow control to the transmitter and reallocation of the data stored in the memory for reducing the total number of the free regions.

2. The communication system according to claim 1, wherein
the memory managing section further manages a usage rate of the memory,
the receiver further includes a comparing section configured to compare the usage rate of the memory with a first threshold, and compare the total number of the free regions with a second threshold, and
the control section requests the transmitter to start the flow control when it has been determined that the usage rate of the memory has exceeded the first threshold and the total number of the free regions has not exceeded the second threshold, and requests the transmitter to start the flow control and reallocates the data stored in the memory when it has been determined that the usage rate of the memory has exceeded the first threshold and the total number of the free regions has exceeded the second threshold.

3. The communication system according to claim 2, wherein
the comparing section further compares the usage rate of the memory with a third threshold, and
the control section requests the transmitter to stop the flow control when it has been determined that the usage rate of the memory has not exceeded the third threshold.

4. The communication system according to claim 1, wherein
the control section reallocates the data stored in the memory so as to store split transmission data in a continuous region on the memory, the split transmission data having been split by the transmitter and stored in the memory.

5. The communication system according to claim 1, wherein
the control section uses a first area of the memory for reallocating the data stored in the memory, and a second area of the memory for storing retransmission data received during the reallocation of the data stored in the memory.

6. The communication system according to claim 2, wherein
the comparing section adjusts the first threshold in accordance with a path-loss of the received data.

7. The communication system according to claim 1, wherein
the data transmitting section preferentially transmits retransmission data upon receiving the request for starting the flow control.

8. A communication apparatus, comprising:
a data receiving section configured to receive data transmitted from a transmitter;
a memory configured to store the received data;
a memory managing section configured to manage a total number of free regions discretely allocated on the memory; and
a control section configured to perform a control process in accordance with the total number of the free regions on the memory, the control process including at least one of request for starting flow control to the transmitter and reallocation of the data stored in the memory for reducing the total number of the free regions.

9. The communication apparatus according to claim 8, further comprising:
a comparing section configured to compare a usage rate of the memory with a first threshold, and compare the total number of the free regions with a second threshold, wherein
the memory managing section further manages the usage rate of the memory, and
the control section requests the transmitter to start the flow control when it has been determined that the usage rate of the memory has exceeded the first threshold and the total number of the free regions has not exceeded the second threshold, and requests the transmitter to start the flow control and reallocates the data stored in the memory when it has been determined that the usage rate of the memory has exceeded the first threshold and the total number of the free regions has exceeded the second threshold.

10. The communication apparatus according to claim 9, wherein
the comparing section further compares the usage rate of the memory with a third threshold, and
the control section requests the transmitter to stop the flow control when it has been determined that the usage rate of the memory has not exceeded the third threshold.

11. The communication apparatus according to claim 8, wherein
the control section reallocates the data stored in the memory so as to store split transmission data in a continuous region on the memory, the split transmission data having been split by the transmitter and stored in the memory.

12. The communication apparatus according to claim 8, wherein
the control section uses a first area of the memory for reallocating the data stored in the memory, and a second area of the memory for storing retransmission data received during the reallocation of the data stored in the memory.

13. The communication apparatus according to claim 9, wherein
the comparing section adjusts the first threshold in accordance with a path-loss of the received data.
